(19) United States
(12) Patent Application Publication
(10) Pub. No.: US 2018/0218328 A1
(43) Pub. Date: Aug. 2, 2018

(54) JOB OFFERINGS BASED ON COMPANY-EMPLOYEE RELATIONSHIPS

(71) Applicant: LinkedIn Corporation, Sunnyvale, CA (US)

(72) Inventors: Krishnaram Kenthapadi, Sunnyvale, CA (US); Kaushik Rangadurai, Sunnyvale, CA (US)

(21) Appl. No.: 15/419,841

(22) Filed: Jan. 30, 2017

(51) Int. Cl. G06Q 10/10; G06F 17/30; H04L 29/08; G06N 99/00; G06Q 10/06

(52) U.S. Cl. CPC G06Q 10/1053; G06F 17/30867; H04L 67/306; G06Q 50/01; G06N 99/005; G06F 17/3053; G06Q 10/063112; G06Q 10/1057

(57) ABSTRACT

Methods, systems, and computer programs are presented for assigning a company culture score to jobs for presentation to a user in response to a search, with the presentation being made within a company culture group. A method includes determining, on a social network, employees that are both similar to the user and work or have worked for a company offering one or more of the jobs. For each job, a server determines a relation score representing the similarity between the user and each employee and an employee fit score representing historical interactions between the employees and the company. The server additionally ranks the jobs within the company culture group for the user based on the company culture score for each job.

### TECHNICAL FIELD

The subject matter disclosed herein generally relates to methods, systems, and programs for finding quality job offerings for a member of a social network.

### BACKGROUND

Some social networks provide job postings to their members. The member may perform a job search by entering a job search query, or the social network may suggest jobs that may be of interest to the member. However, current job search methods may miss valuable opportunities for a member because the job search engine limits the search to specific parameters. For example, the job search engine may look for matches of a job in the title to the member's title, but there may be quality jobs that are associated with a different title that would be of interest to the member.

Further, existing job search methods may focus only on the job description or the member's profile, without considering the member's preferences for job searches that go beyond the job description or other information that may help find the best job postings for the member.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a network architecture, according to some example embodiments, including a social networking server.

FIG. 2 is a screenshot of a user interface that includes job recommendations, according to some example embodiments.

FIG. 3 is a screenshot of a user's profile view, according to some example embodiments.

FIG. 4 is a diagram of a user interface, according to some example embodiments, for presenting job postings to a member of a social network.

FIG. 5 is a detail of a company culture group area in a user interface, according to some example embodiments.

FIG. 6 illustrate the scoring of a job for a member, according to some example embodiments.

FIG. 7 further shows scoring the job for the member while incorporating groups, in some embodiments.

FIG. 8 is a diagram that depicts a scoring of a company based on anticipated cultural fit of a searching member within a company (cultural fit score).

FIG. 9 is a diagram that depicts further details of scoring a company based on anticipated cultural fit, including a loyalty value and a benefit value.

FIG. 10 illustrates a selection process of employees with which to determine relation scores and where a limited number of employees are chosen.

FIG. 11 illustrates the training and use of a machine-learning program, according to some example embodiments.

FIG. 12 is an additional illustration of a method for assigning a company culture score in response to a search for a member in some example embodiments.

FIG. 13 illustrates the cultural fit prediction system for implementing example embodiments.

FIG. 14 is a flowchart of a method, according to some example embodiments, for assigning a company culture score in response to a search for a member.

FIG. 15 is a block diagram illustrating an example of a software architecture that may be installed on a machine, according to some example embodiments.

FIG. 16 is a diagrammatic representation of a machine in the form of a computer system within which a set of instructions may be executed for causing the machine to perform any one or more of the methodologies discussed herein, according to an example embodiment.

### DETAILED DESCRIPTION

Example methods, systems, and computer programs are directed to grouping job postings for presentation to a user in response to a search. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

One of the goals of the present embodiments is to personalize and redefine how job postings are searched and presented to job seekers. Another goal is to explain better why particular candidate jobs are recommended to the job seekers. The presented embodiments provide, to both active and passive job seekers, valuable job recommendation insights, thereby greatly improving their ability to find and assess jobs that meet their needs.

Instead of providing a single job recommendation list for a member, embodiments presented herein define a plurality of groups, and the job recommendations are presented within the groups. Each group provides an indication of a feature that is important to the member for selecting from the group, such as how many people have transitioned from the university of the member to the company of the job, who would be a virtual team for the member if the member joined the company, and so forth. Thus, the embodiments are able to provide insight into the methods of job selection to the user by providing groups of jobs, with all jobs in the group sharing one or more features. Thus, the user is given insight into why certain jobs are presented within a particular group.

Embodiments presented herein determine companies with a company culture that best suit a member's cultural needs by selecting former or current employees that that are similar to the searching member and analyzing the relationship between these members and the companies. Thus, a value can be presented to a member of how well a company fits the searching member's cultural needs based on using similar employees of a company as proxies for evaluating the relationship between the member and company. It should be appreciated that “employee” as referred to herein includes both former employees and current employees unless distinguished. Embodiments presented herein analyze data to compare jobs, companies, and members and determine a cultural fit score for each job that best anticipates future benefits experienced by the member should the member take the job.

One general aspect includes a method for identifying, by a server having one or more processors, a plurality of jobs presentable within a company culture group, the identification in response to a job search for a searching member of a social network. The method also includes operations for selecting employees of the company offering the job, with the employees having worked for the company for a definite length of time. The method also includes operations for determining a relation score representing a similarity between the searching member and each employee and an employee fit score representing historical interactions between the selected employees and the company. The method also includes operations for calculating a cultural fit score for each job based on the relation scores and the employee fit score. The method also includes operations to rank the jobs based on the cultural fit scores and operations for presenting the jobs within a cultural fit group area in an order based on the ranking.

In some embodiments the historical interactions include a benefit value measuring the performance, or level of benefit, provided to employees by the company. In some embodiments, the operations of the method include determining a similarity between the searching member and an employee by using a machine-learning tool to compare a skill set within a member characteristic of the searching member with a skill set within a member characteristic of the employee. In some embodiments, the method further includes selecting an employee based on a similarity criterion between the searching member and the former employee being fulfilled.

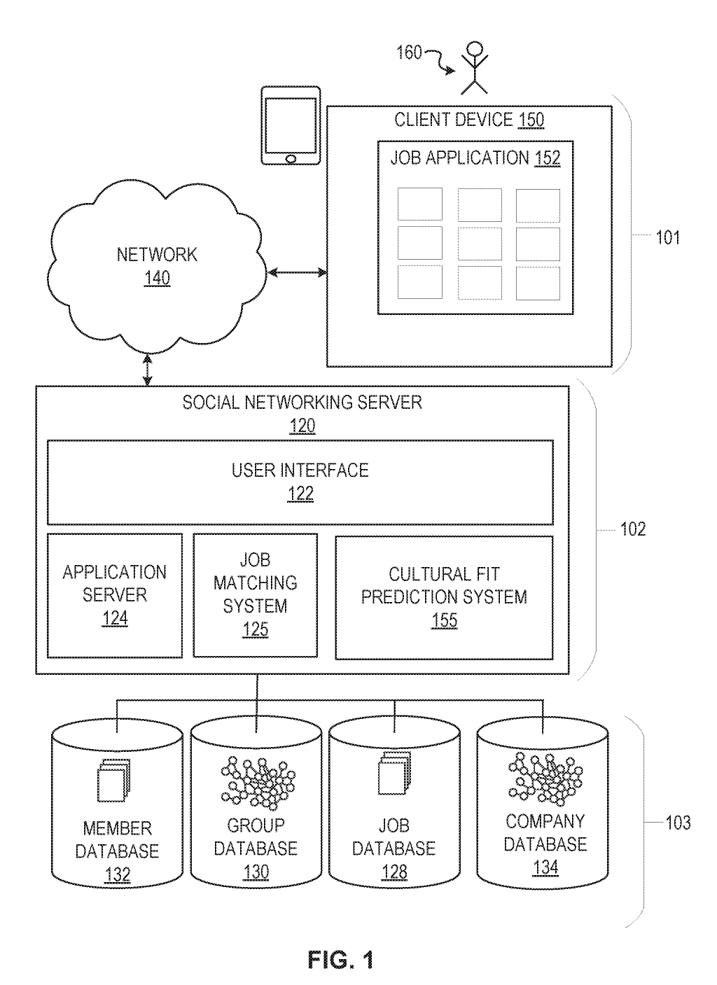

FIG. 1 is a block diagram illustrating a network architecture, according to some example embodiments, including a social networking server 120. As shown in FIG. 1, the network architecture includes three layers: a data layer 103, an application logic layer 102, and a device layer 101. The layers communicate over a network 140 (e.g. the internet). The data layer 103 includes several databases, including a member database 132 for storing data for various entities of the social networking server 120, including member profiles, company profiles, and educational institution profiles, as well as information concerning various online or offline groups. Of course, in various alternative embodiments, any number of other entities might be included in the social graph, and as such, various other databases may be used to store data corresponding with other entities.

Consistent with some embodiments, when a person initially registers to become a member of the social networking server 120, the person will be prompted to provide some personal information, such as his or her name, age (e.g., birth date), gender, interests, contact information, home town, address, spouse's and/or family members' names, educational background (e.g., schools, majors, etc.), current job title, job description, industry, employment history, skills, professional organizations, interests, and so on. This information is stored, for example, as member attributes in the member database 132.

Additionally, the data layer 103 includes a job database 128 for storing job data. The job data includes information collected from a company offering a job, including experience required, location, duties, pay, and other information. This information is stored, for example, as job attributes in the job database 128.

Additionally, the data layer 103 includes a company database 134 for storing company data. The company data includes company information, such as company name, industry associated with the company, number of employees at the company, address of the company, overview description of the company, and job postings associated with the company. Additionally, the company data includes a benefit value that measures benefits experienced by employees that work for the company. The benefit value may be determined by assessing various features, including the provision of company meals, rate of promotion within the company, vacation time, and starting salary.

Once registered, a member may invite other members, or be invited by other members, to connect via the social networking server 120. A “connection” may specify a bilateral agreement by the members, such that both members acknowledge the establishment of the connection. Similarly, in some embodiments, a member may elect to “follow” another member. In contrast to establishing a connection, the concept of “following” another member typically is a unilateral operation, and at least in some embodiments, does not prompt acknowledgement or approval by the member who is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking server 120. In some example embodiments, because the content selection algorithm selects content relating to or associated with the particular entities that a member is connected with or is following, as a member connects with and/or follows other entities, the universe of available content items for presentation to the member in his or her content stream increases.

Additionally, the data layer 103 includes a group database 130 for storing group data. The group database 130 includes information about groups (e.g., clusters) of jobs that have job attributes in common with each other. The group data includes various group features comprising a characteristic for the group, as discussed in more detail below. This information is stored, for example, as job attributes in the job database 128.

As members interact with various applications, content, and user interfaces of the social networking server 120, information relating to the member's activity and behavior may be stored in a database, such as the member database 132 and the job database 128.

The social networking server 120 may provide a broad range of other applications and services that allow members the opportunity to share and receive information, often customized to the interests of the member. In some embodiments, members of the social networking server 120 may be able to self-organize into groups, or interest groups, organized around a subject matter or a topic of interest. In some embodiments, members may subscribe to or join groups affiliated with one or more companies. For instance, in some embodiments, members of the social networking server 120 may indicate an affiliation with a company at which they are employed, such that news and events pertaining to the company are automatically communicated to the members in their personalized activity or content streams. In some embodiments, members may be allowed to subscribe to receive information concerning companies other than the company with which they are employed. Membership in a group, a subscription or following relationship with a company or group, and an employment relationship with a company are all examples of different types of relationships that may exist between different entities, as defined by the social graph and modeled with social graph data of the member database 132.

The application logic layer 102 includes various application server modules 124, which, in conjunction with a user interface module 122, generate various user interfaces with data retrieved from various data sources or data services in the data layer 103. In some embodiments, individual application server modules 124 are used to implement the functionality associated with various applications, services, and features of the social networking server 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, the social networking server 120 may include a job matching system 125, which creates a job display on a job application 152 on a client device 150. Also included in the social networking server 120 is a cultural fit prediction system 155, which determines a company culture score for each job and causes presentation of a company culture group area that is viewable by a searching member 160.

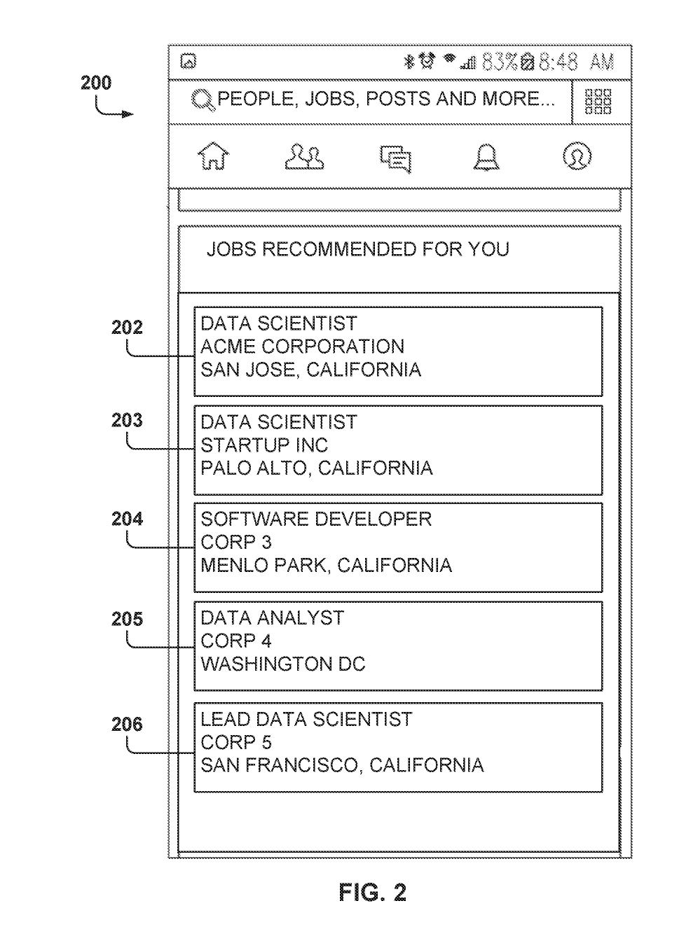

FIG. 2 is a screenshot of a user interface 200 that includes recommendations for jobs 202-206 within the job application 152, according to some example embodiments. In one example embodiment, the social network user interface provides job recommendations, which are job postings that match the job interests of the user and that are presented without a specific job search request from the user (e.g., job suggestions).

In another example embodiment, a job search interface is provided for entering job searches, and the resulting job matches are presented to the user in the user interface 200.

As the user scrolls down the user interface 200, more job recommendations are presented to the user. In some example embodiments, the job recommendations are prioritized to present jobs in an estimated order of interest to the user.

The user interface 200 presents a “flat” list of job recommendations as a single list. Other embodiments presented below utilize a “segmented” list of job recommendations where each segment is a group that is associated with a related reason indicating why these jobs are being recommended within the group.

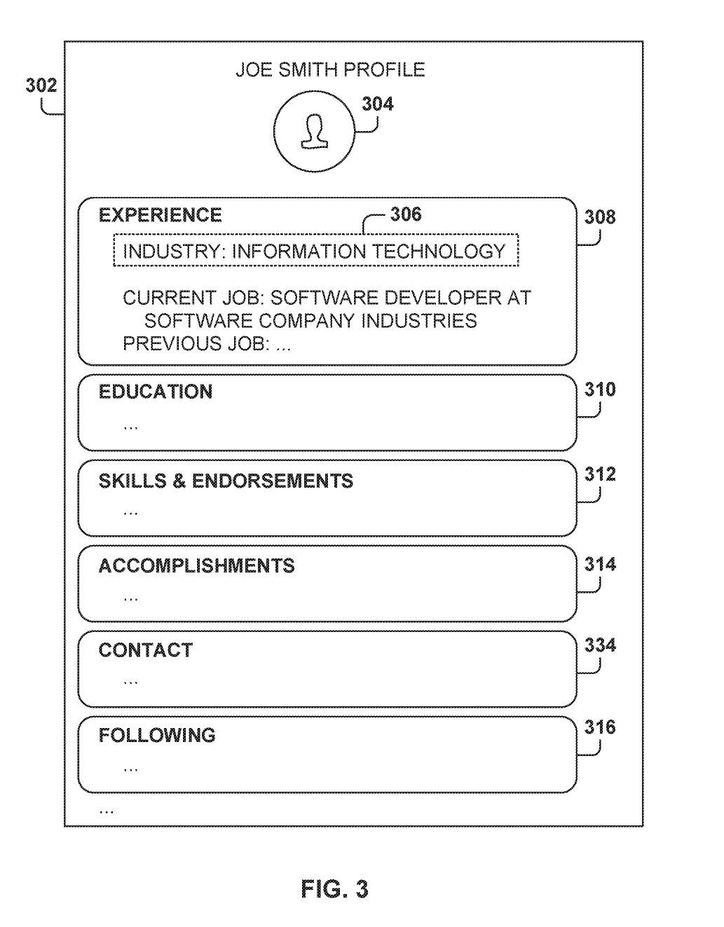

FIG. 3 is a screenshot of a user's profile view, according to some example embodiments. Each user in the social network has a member profile 302, which includes information about the user. The member profile 302 is configurable by the user and also includes information based on the user's activity in the social network (e.g., likes, posts read).

In one example embodiment, the member profile 302 may include information in several categories, such as a profile picture 304, experience 308, education 310, skills and endorsements 312, accomplishments 314, contact information 334, following 316, and the like. Skills include professional competences that the member has, and the skills may be added by the member or by other members of the social network. Example skills include C++, Java, Object Programming, Data Mining, Machine Learning, Data Scientist, and the like. Other members of the social network may endorse one or more of the skills and, in some example embodiments, the member's account is associated with the number of endorsements received for each skill from other members.

The experience 308 information includes information related to the professional experience of the user. In one example embodiment, the experience 308 information includes an industry 306, which identifies the industry in which the user works. In one example embodiment, the user is given an option to select an industry 306 from a plurality of industries when entering this value in the member profile 302. The experience 308 information area may also include information about the current job and previous jobs held by the user.

The education 310 information includes information about the educational background of the user, including the educational institutions attended by the user, the degrees obtained, and the field of study of the degrees. For example, a member may list that the member attended the University of Michigan and obtained a graduate degree in computer science. For simplicity of description, the embodiments presented herein are presented with reference to universities as the educational institutions, but the same principles may be applied to other types of educational institutions, such as high schools, trade schools, professional training schools, and the like.

The skills and endorsements 312 information includes information about professional skills that the user has identified as having been acquired by the user and endorsements entered by other users of the social network supporting the skills of the user. The accomplishments 314 area includes accomplishments entered by the user, and the contact information 334 includes contact information for the user, such as an email address and phone number. The following 316 area includes the names of entities in the social network being followed by the user.

The skills within the skills and endorsements 312 information are aggregated by the system to form a skill set for the user that can be compared to other users. In some embodiments, this skill set is part of a member characteristic for the user, the member characteristic including information such as the skill set for the user, profile information, education 310 information, and other data that is further comparable to other members.

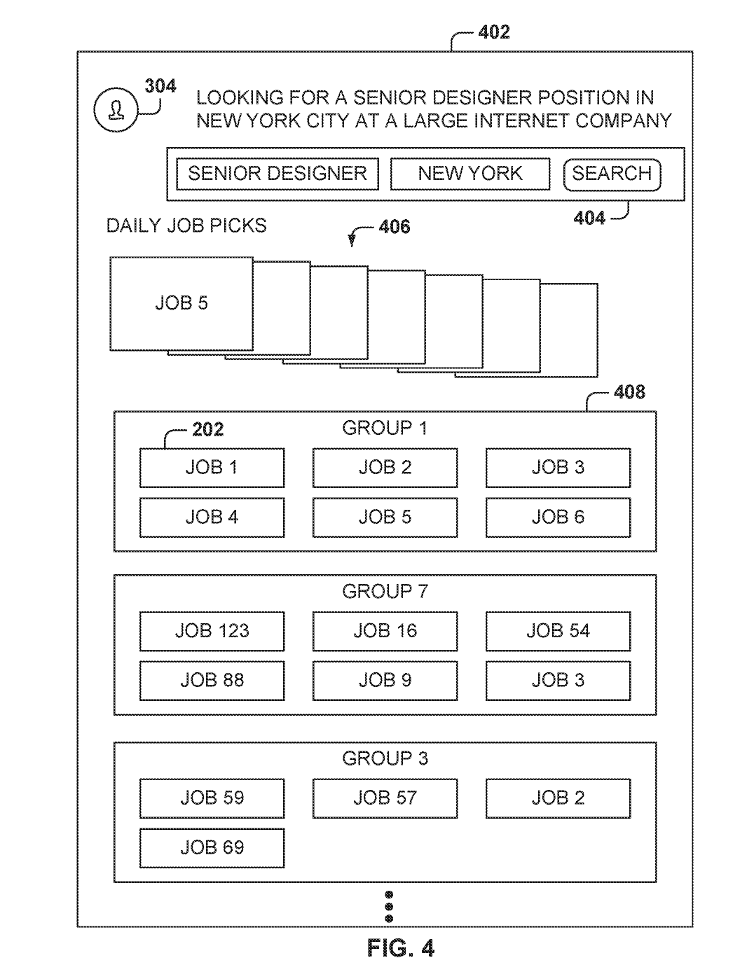

FIG. 4 is a diagram of a user interface 402, according to some example embodiments, for presenting job postings to a member of the social network. The user interface 402 includes the profile picture 304 of the member, a search section 404, a daily jobs section 406, and one or more group areas 408. In some example embodiments, a message next to the profile picture 304 indicates the goal of the search, e.g., “Looking for a senior designer position in New York City at a large Internet company.”

The search section 404, in some example embodiments, includes two boxes for entering search parameters: a keyword input box for entering any type of keywords for the search (e.g., job title, company name, job description, skill, etc.), and a geographic area input box for entering a geographic area for the search (e.g., New York). This allows members to execute searches based on keyword and location. In some embodiments, the geographic area input box includes one or more of city, state, ZIP code, or any combination thereof.

In some example embodiments, the search boxes may be prefilled with the user's title and location if no search has been entered yet. Clicking the search button causes the search of jobs based on the keyword inputs and location. It is to be noted that the inputs are optional, and only one search input may be entered at a time, or both search boxes maybe filled in.

The daily jobs section 406 includes information about one or more jobs selected for the user, based on one or more parameters, such as member profile data, search history, job match to the member, recentness of the job, whether the user is following the job, and so forth.

Each group area 408 includes one or more jobs 202 for presentation in the user interface 402. In one example embodiment, the group area 408 includes one to six jobs 202 with an option to scroll the group area 408 to present additional jobs 202, if available.

Each group area 408 provides an indication of why the member is being presented with those jobs, which identifies the characteristic of the group. There could be several types of reasons related to the connection of the user to the job, the affinity of the member to the group, the desirability of the job, or the time deadline of the job (e.g., urgency). The reasons related to the connection of the user to the job may include relationships between the job and the social connections of the member (e.g., “Your connections can refer you to this set of jobs”), a quality of a fit between the job and the user characteristics (e.g., “This is a job from a company that hires from your school”), a quality of a match between the member's talent and the job (e.g., “You would be in the top 90% of all applicants), and so forth.

Further, the group characteristics may be implicit (e.g., “These jobs are recommended based on your browsing history”) or explicit (e.g., “These arej obs from companies you followed”). The desirability reasons may include popularity of the job in the member's area (e.g., most-viewed by other members or most applications received), jobs from in-demand start-ups in the member's area, and popularity of the job among people with the same title as the member. Further yet, the time-urgency reasons may include “Be the first to apply to these jobs,” or “These jobs will be expiring soon.”

It is to be noted that the embodiments illustrated in FIG. 4 are examples and do not describe every possible embodiment. Other embodiments may utilize different layouts or groups, present fewer or more jobs, present fewer or more groups, etc. The embodiments illustrated in FIG. 4 should therefore not be interpreted to be exclusive or limiting, but rather illustrative.

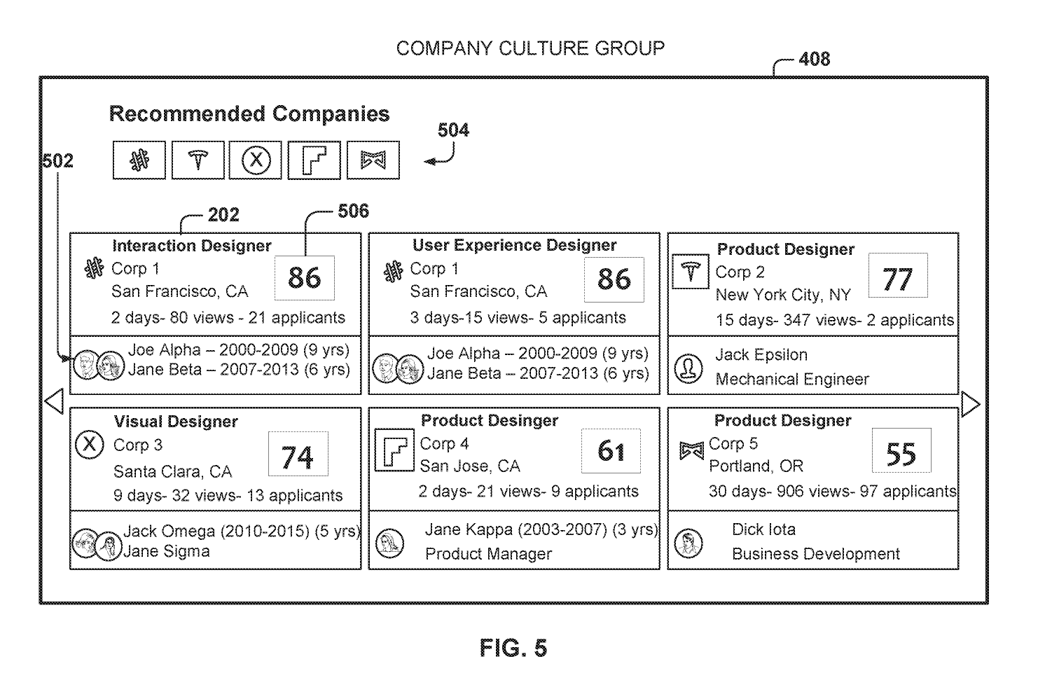

FIG. 5 is a detail of a company culture group area 408 in the user interface, according to some example embodiments. In one example embodiment, the company culture group area 408 includes recommendations of jobs 202, which provide information about one or more jobs. The company culture group area 408 also specifically lists companies 504 that would provide a good cultural fit for the user. For example, the information about the job includes the title of the job, the company offering the job, activity from other members (number of views, number of applicants), the location of the job, and other members in the searching member's 160 social network are currently formally employed by offering the job. In one example embodiment, the group area 408 includes profile pictures 502 within the recommendations of jobs 202 of people who are current or former employees of companies 504 offering the job recommendations. Additionally, the jobs 202 each include a company culture score display 506 representing the anticipated cultural fit of the searching member 160 with the job 202.

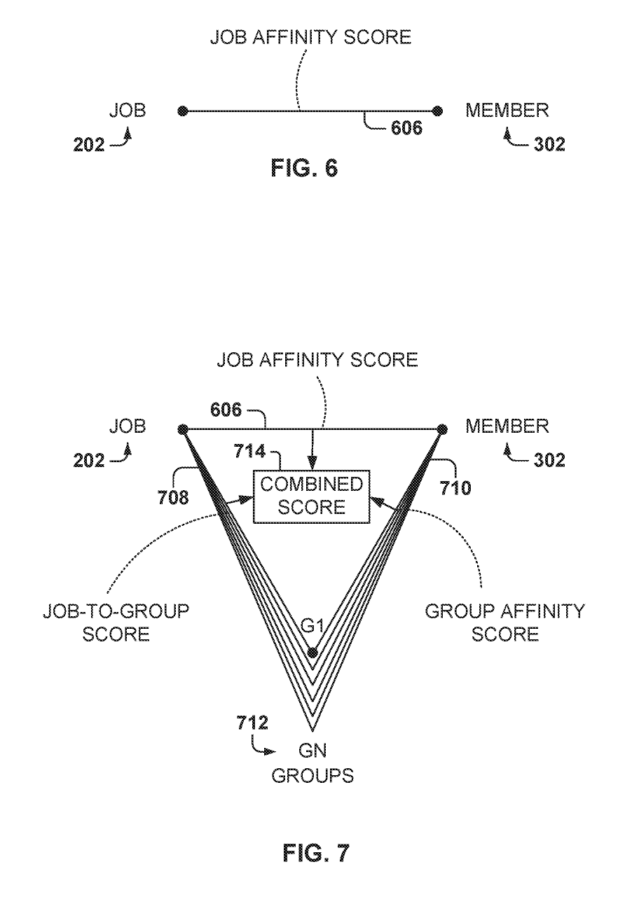

FIGS. 6-7 illustrate the scoring of a job for a member, according to some example embodiments. FIG. 6 illustrates the scoring, also referred to herein as ranking, of a job 202 for a member associated with a member profile 302 based on a job affinity score 606.

The job affinity score 606, between a job 202 and a member 302, is a value that measures how well the job 202 matches the interest of the member 302 in finding the job 202. A so-called “dream job” for a member would be the perfect job for the member and would have a high, or even maximum, value, while a job that the member is not interested in at all (e.g., in a different professional industry) would have a low job affinity score 606. In some example embodiments, the job affinity score 606 is a value between zero and one, or a value between zero and 100, although other ranges are possible.

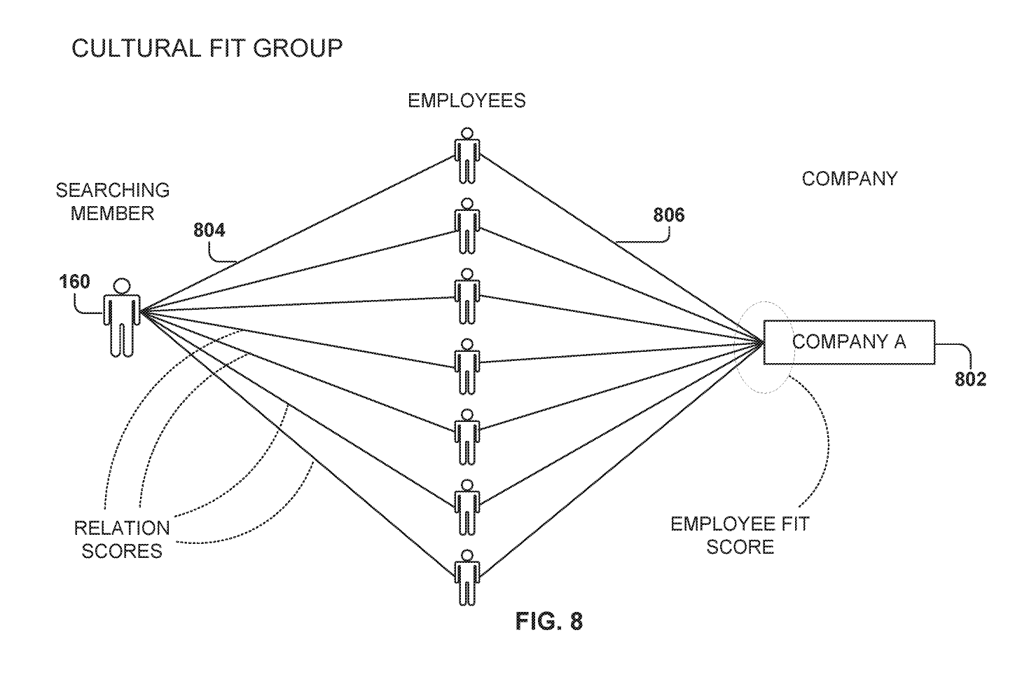

In some example embodiments, a machine-learning program is used to calculate the job affinity scores 606 for the jobs 202 available to the member. The machine-learning program is trained with existing data in the social network, and the machine-learning program is then used to evaluate jobs 202 based on the features used by the machine-learning program. In some example embodiments, the features include any combination of job data (e.g., job title, job description, company, geographic location, etc.), member profile data, member search history, employment of social connections of the member, job popularity in the social network, number of days the job has been posted, company reputation, company size, company age, profit vs. nonprofit company, and pay scale. More details are provided below with reference to FIG. 8 regarding the training and use of the machine-learning program.

FIG. 7 illustrates the scoring of a job 202 for a member associated with the member profile 302, according to some example embodiments, based on three parameters: the job affinity score 606, a job-to-group score 708, and a group affinity score 710. Broadly speaking, the job affinity score 606 indicates how relevant the job 202 is to the member, the job-to-group score 708 indicates how relevant the job 202 is to a group 712, and the group affinity score 710 indicates how relevant the group 712 is to the member.

The group affinity score 710 indicates how relevant the group 712 is to the member, where a high affinity score indicates that the group 712 is very relevant to the member and should be presented in the user interface, while a low affinity score indicates that the group 712 is not relevant to the member and may be omitted from presentation in the user interface.

The group affinity score 710 is used, in some example embodiments, to determine which groups 712 are presented in the user interface, as discussed above, and the group affinity score 710 is also used to order the groups 712 when presenting them in the user interface, such that the groups 712 may be presented in the order of their respective group affinity scores 710. It is to be noted that if there is not enough “liquidity” of jobs for a group 712 (e.g., there are not enough jobs for presentation in the group 712), the group 712 may be omitted from the user interface or presented with lower priority, even if the group affinity score 710 is high.

In some example embodiments, a machine-learning program is utilized for calculating the group affinity score 710. The machine-learning program is trained with member data, including interactions of users with the different groups 712. The data for the particular member is then utilized by the machine-learning program to determine the group affinity score 710 for the member with respect to a particular group 712. The features utilized by the machine-learning program include the history of interaction of the member with jobs from the group 712, click data for the member (e.g., a click rate based on how many times the member has interacted with the group 712), member interactions with other members who have a relationship to the group 712, and the like. For example, one feature may include an attribute that indicates whether the member is a student. If the member is a student, features such as social connections or education-related attributes will be important to determine which groups are of interest to the student. On the other hand, a member who has been out of school for 20 years or more may not be as interested in education-related features.

Another feature of interest to determine group participation is whether the level of benefit provided by the companies that the member has previously applied for. If the member typically pursues jobs that include certain levels of benefit (e.g. swift promotion, company meals, etc.) the cultural fit group will provide the member with jobs for companies that provide similar levels of benefit. In some embodiments, these features are included in a member characteristic of the member that can later be compared to other member characteristics.

The job-to-group score 708 between a job 202 and a group 712 indicates the job 202's strength within the context of the group 712, where a high job-to-group score 708 indicates that the job 202 is a good candidate for presentation within the group 712 and a low job-to-group score 708 indicates that the job 202 is not a good candidate for presentation within the group 712. In some example embodiments, a predetermined threshold is identified, wherein jobs 202 with a job-to-group score 708 equal to or above the predetermined threshold are included in the group 712, and jobs 202 with a job-to-group score 708 below the predetermined threshold are not included in the group 712.

In the company culture group, the job-to-group score 708 measures a level of relevance the job has to the company culture group. In an example embodiment, this level of relevance is derived by ranking the company culture scores for each job, as discussed below. Thus, the job-to-group score 708 provides an indication of how important it is to present the job to the user within the company culture group. This is useful, because a company may offer certain benefits to employees and employees in turn may display loyalty to the company, creating a positive company culture. If members that are similar to the searching member 160 display loyalty to the company in response to benefits offered, this indicates that the searching member 160 may similarly benefit from working at the company.

For example, in a group 712 that presents jobs within the social network of the member, if there is a job 202 for a company within the network of the member, the job-to-group score 708 indicates how strong the member's network is for reaching the company of the job 202.

In some example embodiments, the job affinity score 606, the job-to-group score 708, and the group affinity score 710 are combined to obtain a combined affinity score 714 for the job 202. The scores may be combined utilizing addition, weighted averaging, or other mathematical operations.

FIG. 8 shows the scoring of the company based on anticipated cultural fit of the searching member 160 within the company (cultural fit score). Multiple relation scores 804 are generated between the searching member 160 and various current and former employees of the company. The relation score 804 is a measure based on a comparison of features located in a member characteristic of the searching member 160 compared to features located in a member characteristic of a first former employee. For example, a feature within the searching member's 160 and the former employee's respective member characteristics may indicate that the members share a common skill, such as the ability to code in PYTHON. In some example embodiments, a relation score 804, representing the similarity (e.g. comparison of member characteristics) of the searching member 160 to the employee, is calculated.

In some example embodiments, a machine-learning program is utilized for calculating the relation score 804. The machine-learning program is trained with member data from the member database 132, including member profile information and interactions of the searching member 160 with former employees of the companies offering jobs. The profile data may include job titles, industry experience, education level, job applications, average length of employment, etc. The data for the former employee and the searching member is then utilized by the machine-learning program to determine the relation score 902 that measures the similarity between a searching member and the employee based on the characteristics of the searching member and the employee.

Similarly, the employee fit score 806 represents a relationship between all employees that have formerly worked or currently work for the company and the company. The employee fit score is calculated based on various historical interactions that occur between employees and the company while the employees work for the company.

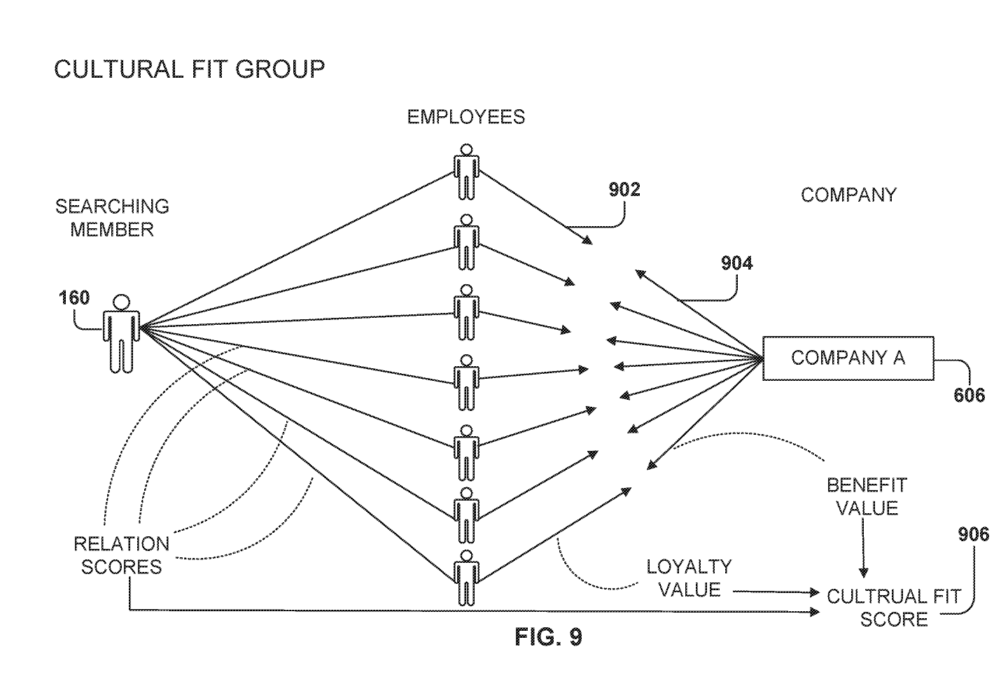

FIG. 9 further displays the way the employee fit score 806 may be separated into a loyalty value 906 from an employee to the company and a benefit value from the company to the employees. These historical interactions may include a loyalty value that is a measure based on the length of time the employee has worked at the company and a benefit value 904 that is a measure of benefits provided by the company to the employee.

In some embodiments, the loyalty value 906 is determined based on a length of time that a former employee remained at the company. For example, if a former employee leaves a company after only a few months of working there, this may indicate that the company is not a very good fit for that former employee, and, using that employee as a proxy for the searching member 160, it can further indicate that the company may not be a good future fit for the searching member 160.

In some embodiments, the loyalty value 906 for a current employee is determined based on an average length of time that former employees have remained at the company. Further, the former employees that are used to determine this average length of time may be selected (such as by a machine learning tool) based on a comparison of a member characteristic of the current employee to the member characteristics of each of the former employees.

The loyalty value, based on length of employment, is more useful for former employees rather than for current employees, since there is a definite end date. For example, a current employee that has worked at a company for 3 years may display different loyalty to the company than a former employee that worked for the company for 3 years, since the current employee may end up working at the company for another 10 years. In some embodiments, the length of time a current employee has worked for the company may be used in determining a loyalty value if the length surpasses a threshold time period. For example, a threshold time period of 6 years may be retrieved from the group database 130. Thus, any employment length by a current employee of less than 6 years will not be considered with regard to the loyalty value. In some embodiments, an average loyalty value for the former employees of the company may be substituted for the loyalty value of a current employee to the company.

In other embodiments, the loyalty value 902 may be based on other features within the member characteristic of the employee that are related to the company. For example, if the employee took a pay cut when starting work for the company, it could indicate that the employee saw additional benefit in the culture of the company to make up for the lower compensation. Additionally, the loyalty value may be based on the current employee being one of the oldest employees at a company (e.g., tenure at the company is within the top 15%), For example, if the current employee has remained at a company longer than 85% of the other current employees of the company, this may indicate that the employee feels more loyalty to the company.

In some embodiments, the benefit value is a common value based on benefits that the company provides to employees and the benefit value is determined based on perks and services offered to employees of the company. For example, a company providing meals to employees would have a higher benefit value than a company that does not provide meals, if all other benefits are equal. Additional benefits may include child-care services, a high rate of promotion, long vacations, training, job variety, and flexible hours.

In some embodiments, the system raises or lowers the benefit value based on a public sentiment about the company derived from news articles. For example, a pharmaceutical company that has been found liable in a largely publicized lawsuit may have a negative public sentiment. In this example, the system determines that the negative public sentiment translates to an adjustment coefficient of 0.885. Thus, the new benefit value would be adjusted down to approximately 88.5% of the previous benefit value. In contrast, a positive public sentiment (such as when a company's product receives positive reviews) results in an adjustment coefficient greater than 1, such as 1.17.

Based on the employee fit score between employees and the company and the relation scores 902 between the searching member 160 and the employees, a cultural fit score 906 may be determined. In some embodiments, an average of the relation scores 902 (derived from using the average benefit value and average loyalty value) are used in combination with the employee fit score 806 to determine the cultural fit score 906 between a company and a searching member, such as in the following equation:

CFS=RS_{Avg}(BV_{Avg}+LV_{Avg})

In the above equation, CFS is the cultural fit score 906, RS_{Avg} is the average relation score 902 (optionally derived through machine-learning) between the searching member 160 and the employees of the company, BV_{Avg} is the average benefit value 904 for employees of the company, and LV_{Avg} is the average loyalty value 902 of employees in the company. In another embodiment, the cultural fit score 906 is determined by first weighting the benefit values and loyalty values for each current or former employee based on the relation score between the searching member 160 and the employee, such as in the following equation:

CFS=[RS₁(BV₁+LV₁)+RS₂(BV₂+LV₂)+ . . . 30 RSₙ(BVₙ+LVₙ)]/n

Thus, the employee fit score 806 for each employee is weighted based on the similarity between the employee and the searching member 160. Although not specifically enumerated, there are numerous other methods of calculating the cultural fit score.

FIG. 8 is an alternative representation of the relation scores 902 and the employee fit score 806 in relation to an example company 802 (COMPANY A). FIG. 9 is a similar representation that specifically shows the loyalty values 902 toward the company from the employee and the benefit value 904 from the company and toward each employee.

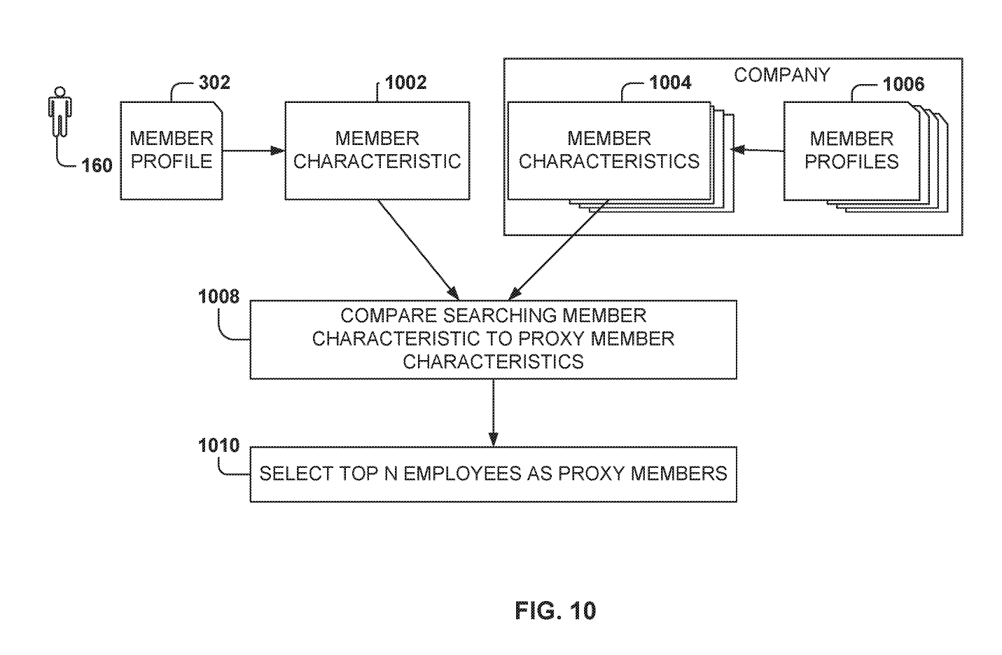

FIG. 10 illustrates a selection process of employees where a limited number of employees are chosen. As discussed previously, the employees are selected based on a comparison of the member characteristic of the searching member 106 and the member characteristics of the employees. The employees that are selected are proxy members, since the system will determine a cultural fit score for the searching member 106 based on the relationships of the proxy members to the company. For example, at operation 1008, a searching member characteristic 1002 from the member profile 302 of the searching member 160 is compared to employee characteristics 1004 from member profiles 1006 of employees within a company (proxy member characteristics). At operation 1008, the system retrieves data, from the searching member characteristic and compares this date to the member characteristics of the employees. In some embodiments the system retrieves additional data, such as data from the group database 130, that indicates a limit to a number of employees (N) that should be evaluated to determine the cultural fit score. At operation 1010, based on the comparison of the searching member characteristic to the member characteristics of the employees, N employees are selected for use in determining the cultural fit score.

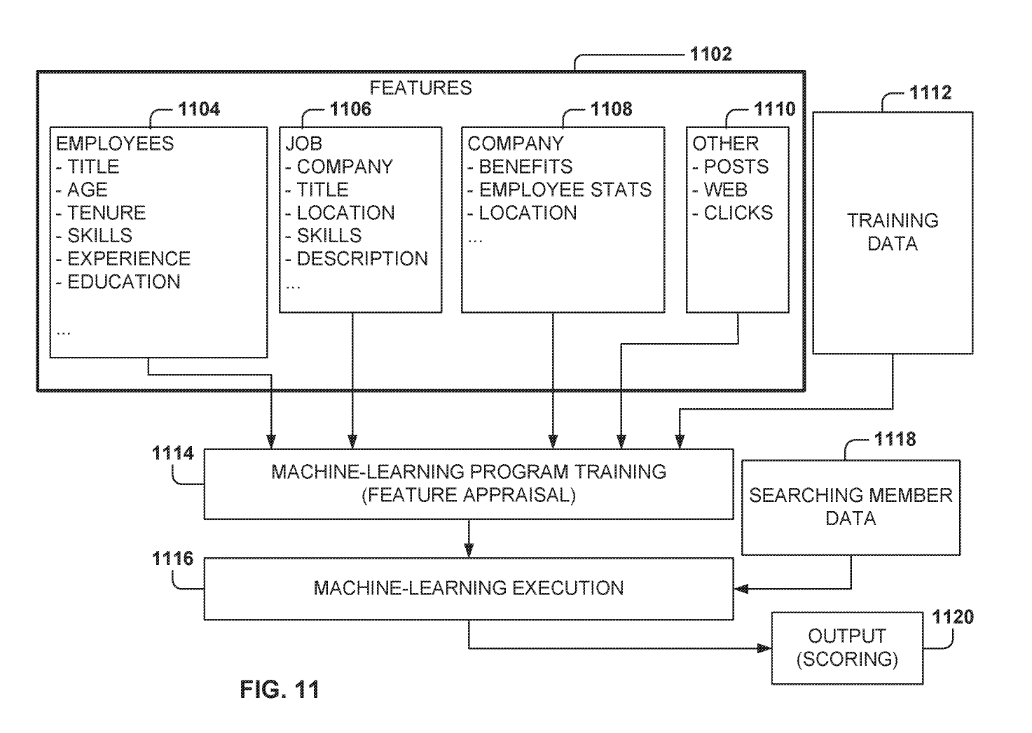

In some embodiments, the employees are selected based a skill vector with the searching member 106, the skill vector being a measure of a relationship between the skill set of the searching member 106 and the skill set of the employee. For example, the skill vectors may be a value between 0 and 1, with 0 representing no relationship at all and 1 representing an identical skill set. A machine learning tool, such as described in FIG. 11, is used to determine the skill vector representing a similarity between the searching member characteristic 1002 and an employee characteristic 1004. For example, a skill vector of 0.024 may be low and the employee related to the skill vector will likely not be selected as a proxy member if only a limited number of proxy members are selected (e.g. N proxy members). Alternatively, if a skill vector for an employee is 0.724, this may be quite high, and the employee will likely be selected as a proxy member.

In some embodiments, the employees are selected based on the searching member 160 and the employee having attained a common job title. For example, if the searching member 160 attained the job title of “Senior software developer” at company X and an employee currently working at company Y has previously held the position of “Senior software developer” for company Z, a machine-learning tool as described in FIG. 11 may select the employee as a proxy employee based, in part, on this common job title.

FIG. 11 illustrates the training and use of a machine-learning program 1116, according to some example embodiments. In some example embodiments, machine-learning programs, also referred to as machine-learning algorithms or tools, are utilized to perform operations associated with job searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 1112 in order to make data-driven predictions or decisions expressed as outputs or assessments (e.g., a score) 1120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

In general, there are two types of problems in machine learning: classification problems and regression problems. Classification problems aim at classifying items into one of several categories (for example, is this object an apple or an orange?). Regression algorithms aim at quantifying some items (for example, by providing a value that is a real number). In some embodiments, example machine-learning algorithms provide a job affinity score 606 (e.g., a number from 1 to 100) to qualify each job as a match for the user (e.g., calculating the job affinity score). In other example embodiments, machine learning is also utilized to calculate the group affinity score 710 and the job-to-group score 708. The machine-learning algorithms utilize the training data 1112 to find correlations among identified features 1102 that affect the outcome.

In one example embodiment, the features 1102 may be of different types and may include one or more of member features 1104, job features 1106, company features 1108, and other features 1110. The member features 1104 may include one or more of the data in the member profile 302, as described in FIG. 3, such as title, skills, experience, education, and so forth. The job features 1106 may include any data related to the job 202, and the group features 1106 may include various data related to the group. In some example embodiments, additional features in the other features 1110 may be included, such as post data, message data, web data, click data, and so forth.

With the training data 1112 and the identified features 1102, the machine-learning tool is trained at operation 1114. The machine-learning tool appraises the value of the features 1102 as they correlate to the training data 1112. The result of the training is the trained machine-learning program 1116.

When the machine-learning program 1116 is used to generate a score, new data, such as member activity 1118, is provided as an input to the trained machine-learning program 1116, and the machine-learning program 1116 generates the score 1120 as output. For example, when a member performs a job search, a machine-learning program, such as the machine-learning program 1116, trained with social network data, uses the member data and job data from the jobs in the database to search for jobs that match the member's profile and activity.

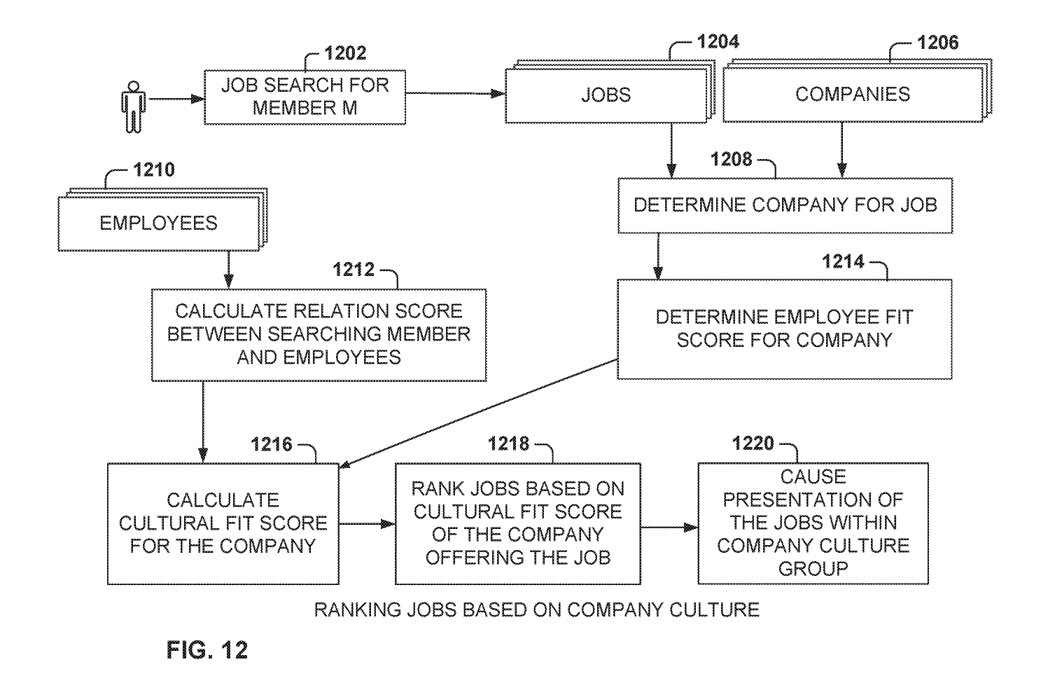

FIG. 12 is an additional illustration of a method for assigning a company culture score in response to a search for a member in some example embodiments. A search for jobs is performed (at operation 1202) for a member, such as the searching member 160. The search may be initiated by the member, such as by navigating to a “recommended jobs” page on a user interface, or may be initiated by the system to suggest jobs to the member. At operation 1208, the system accesses a plurality of jobs 1204, such as from the job database 128, and companies 1206, such as from the group database 130 to determine which of the companies 1206 is offering each job 1204. At operation 1212, the system calculates a relation score 902 between the searching member and each former employee of the company. In some embodiments, the relation score is calculated using systems described above and member data from former employees 1210, such as from the member database 132.

At operation 1214, the system calculates the employee fit score 806 for the company based on a benefit value 904 representing a measure of benefit to the employee by the company and a loyalty value 902 representing a measure of the employee's desire or previous desire to remain employed by the company. At operation 1216, the system calculates a cultural fit score for the company by assessing the employee fit score 604 and the relation score 602, as described above.

At operations 1218-1220, the system ranks the jobs 202 based on the cultural fit score 906 of the company offering the job and presents the jobs 202 to the searching member 106 within the cultural fit group area 408 based on the ranking. For example, a first job with a cultural fit score 906 that is higher than a second job will be ranked ahead of the second job. Then, at operation 1220, when the system presents the jobs 202 within the company culture group area 408, the first job will be presented higher within the company culture group area 408 and thus likely viewable to the searching member 160 before the second job.

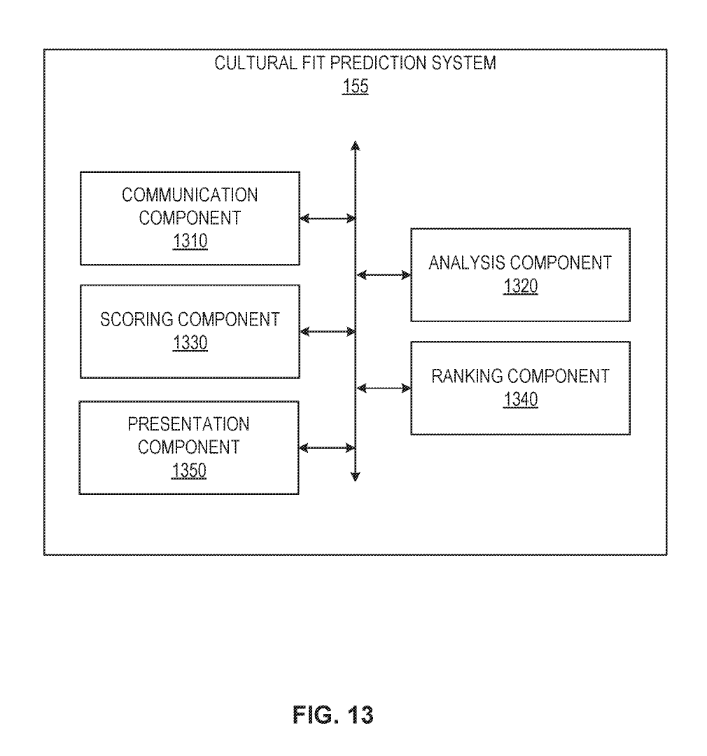

FIG. 13 illustrates the cultural fit prediction system 155 for implementing example embodiments. In one example embodiment, the cultural fit prediction system 155 includes a communication component 1310, an analysis component 1320, a scoring component 1330, a ranking component 1340, and a presentation component 1350.

The communication component 1310 provides various data retrieval and communications functionality. In example embodiments, the communication component 1310 retrieves data from the databases 132, 128, 130, and 134 including member data, jobs, group data, company features 1108, job features 1106, and member features 1104. The communication component 1310 can further retrieve data from the databases 132, 128, 130, and 134 related to rules such as threshold data, data related to a maximum number of employees to be used for generating relation scores 902 with the searching member 160, and data related to the maximum quantity of jobs displayable within the company culture group area 408.

The analysis component 1320 performs operations such as selecting the employees for calculation of the relation scores and application of rules regarding the selection of the employees. Additionally, the analysis component 1320 performs machine-learning programs 1116 described in FIG. 11. In some embodiments, the analysis component 1320 further compares groups to determine one or more groups for presentation of a job and also a presenting group for the job.

The scoring component 1330 calculates various scores as illustrated above with reference to FIGS. 6-9. The scoring component 1330 calculates the job-to-group scores 708, group affinity scores 710, relation scores 902, employee fit scores 806, and cultural fit scores 906 as illustrated above with reference to FIGS. 6B and 7-9.

The ranking component 1340 provides functionality to rank jobs by cultural fit score 906, as determined by the scoring component 1330, within the cultural fit group. In some example embodiments, the jobs are ranked from highest cultural fit score 906 to lowest cultural fit score 906. In alternative embodiments, jobs may be ranked based on an average cultural fit score 906 of the company offering the job.

The presentation component 1350 provides functionality to present a display of the cultural fit group area 408 including the jobs with a display of the cultural fit score to the searching member 160, such as on the user interface 402.

It is to be noted that the embodiments illustrated in FIG. 13 are examples and do not describe every possible embodiment. Other embodiments may utilize different servers or additional servers, combine the functionality of two or more servers into a single server, utilize a distributed server pool, and so forth. The embodiments illustrated in FIG. 13 should therefore not be interpreted to be exclusive or limiting, but rather illustrative.

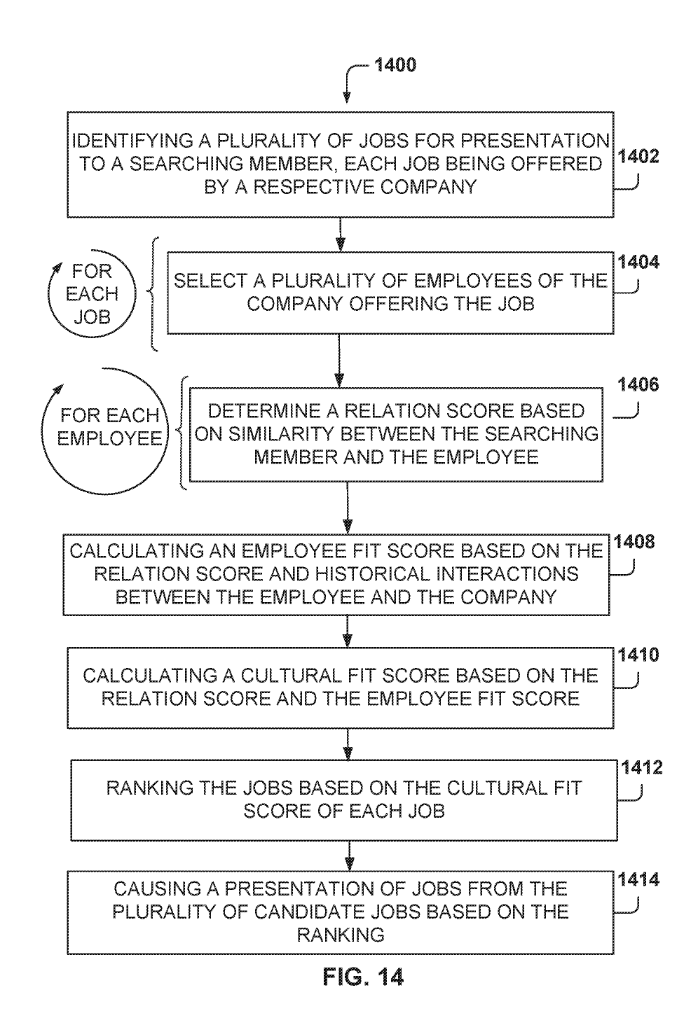

FIG. 14 is a flowchart of a method 1400, according to some example embodiments, for assigning a company culture score in response to a search for a member. While the various operations in this flowchart are presented and described sequentially, one of ordinary skill will appreciate that some or all of the operations may be executed in a different order, be combined or omitted, or be executed in parallel.

Operation 1402 is for identifying, by a server having one or more processors, a plurality of jobs for presentation to a searching member 160 in response to a job search requested by the searching member 160. From operation 1402, the method 1400 flows to operation 1404, where the server selects a plurality of employees for each job, with the employees having worked for or currently working for the company that is offering the job. From operation 1404, the method 1400 flows to operation 1406, where the server determines a relation score for each employee based on a similarity between the searching member 160 and the employee. From operation 1406, the method 1400 flows to operation 1408, where the server calculates an employee fit score based on historical interactions between the employee and the company, the historical interactions specifically represented by a loyalty value to the company by each employee and a benefit value 904 to employees by the company. The method 1400 then flows to operation 1410 where, based on the employee fit score 1408 and the relation score 1406, the server calculates a cultural fit score for each job 202. The method 1400 then flows to operation 1412 where the jobs are ranked by the server based on the culture fit score of each job. Finally, the method 1400 flows to operation 1414, where the system causes presentation of the jobs within the cultural fit group area 408 based on the ranking of the jobs by cultural fit score.

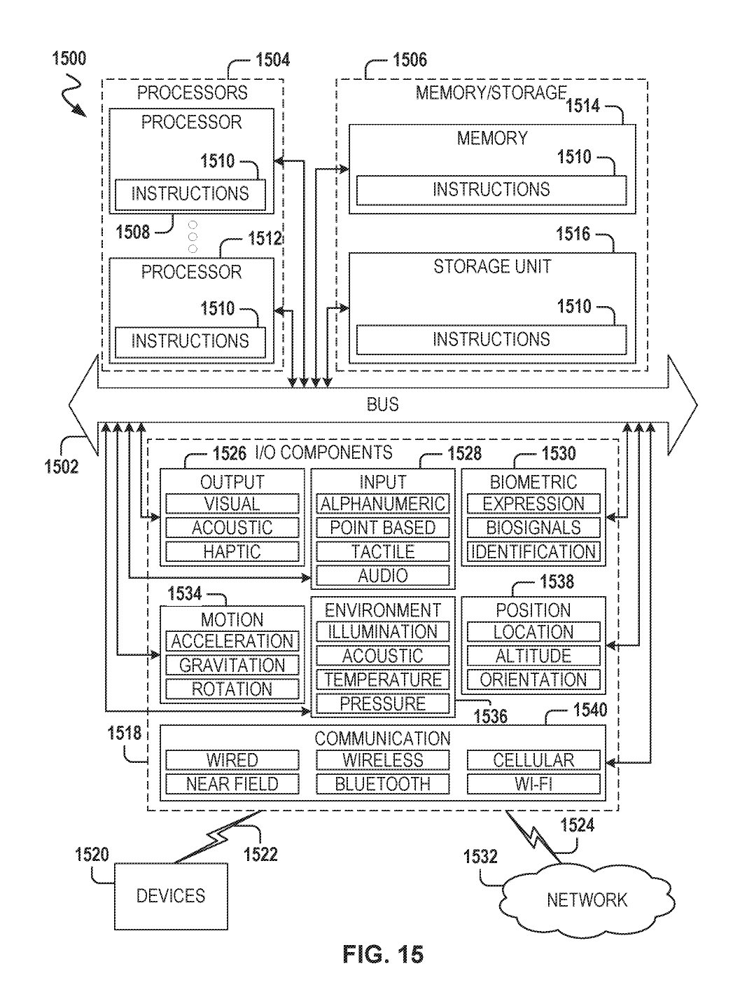

FIG. 15 is a block diagram illustrating components of a machine 1500, according to some example embodiments, able to read instructions from a machine-readable medium (e.g., a machine-readable storage medium) and perform any one or more of the methodologies discussed herein. Specifically, FIG. 15 shows a diagrammatic representation of the machine 1500 in the example form of a computer system, within which instructions 1510 (e.g., software, a program, an application, an applet, an app, or other executable code) for causing the machine 1500 to perform any one or more of the methodologies discussed herein may be executed. For example, the instructions 1510 may cause the machine 1500 to execute the flow diagrams of FIG. 14. Additionally, or alternatively, the instructions 1510 may implement the job-scoring programs and the machine-learning programs associated with them. The instructions 1510 transform the general, non-programmed machine 1500 into a particular machine 1500 programmed to carry out the described and illustrated functions in the manner described.

In alternative embodiments, the machine 1500 operates as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1510, sequentially or otherwise, that specify actions to be taken by the machine 1500. Further, while only a single machine 1500 is illustrated, the term “machine” shall also be taken to include a collection of machines 1500 that individually or jointly execute the instructions 1510 to perform any one or more of the methodologies discussed herein.

The machine 1500 may include processors 1504, memory/storage 1506, and I/O components 1518, which may be configured to communicate with each other such as via a bus 1502. In an example embodiment, the processors 1504 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1508 and a processor 1512 that may execute the instructions 1510. The term “processor” is intended to include multi-core processors that may comprise two or more independent processors (sometimes referred to as “cores”) that may execute instructions contemporaneously. Although FIG. 15 shows multiple processors 1504, the machine 1500 may include a single processor with a single core, a single processor with multiple cores (e.g., a multi-core processor), multiple processors with a single core, multiple processors with multiples cores, or any combination thereof.

The memory/storage 1506 may include a memory 1514, such as a main memory, or other memory storage, and a storage unit 1516, both accessible to the processors 1504 such as via the bus 1502. The storage unit 1516 and memory 1514 store the instructions 1510 embodying any one or more of the methodologies or functions described herein. The instructions 1510 may also reside, completely or partially, within the memory 1514, within the storage unit 1516, within at least one of the processors 1504 (e.g., within the processor's cache memory), or any suitable combination thereof, during execution thereof by the machine 1500. Accordingly, the memory 1514, the storage unit 1516, and the memory of the processors 1504 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1510. The term “machine-readable medium” shall also be taken to include any medium, or combination of multiple media, that is capable of storing instructions (e.g., instructions 1510) for execution by a machine (e.g., machine 1500), such that the instructions, when executed by one or more processors of the machine (e.g., processors 1504), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1518 may include a wide variety of components to receive input, provide output, produce output, transmit information, exchange information, capture measurements, and so on. The specific I/O components 1518 that are included in a particular machine will depend on the type of machine. For example, portable machines such as mobile phones will likely include a touch input device or other such input mechanisms, while a headless server machine will likely not include such a touch input device. It will be appreciated that the I/O components 1518 may include many other components that are not shown in FIG. 15. The I/O components 1518 are grouped according to functionality merely for simplifying the following discussion, and the grouping is in no way limiting. In various example embodiments, the I/O components 1518 may include output components 1526 and input components 1528. The output components 1526 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1528 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1518 may include biometric components 1530, motion components 1534, environmental components 1536, or position components 1538 among a wide array of other components. For example, the biometric components 1530 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1534 may include acceleration sensor components (e.g., accelerometer), gravitation sensor components, rotation sensor components (e.g., gyroscope), and so forth. The environmental components 1536 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1538 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1518 may include communication components 1540 operable to couple the machine 1500 to a network 1532 or devices 1520 via a coupling 1524 and a coupling 1522, respectively. For example, the communication components 1540 may include a network interface component or other suitable device to interface with the network 1532. In further examples, the communication components 1540 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1520 may be another machine or any of a wide variety of peripheral devices (e.g., a peripheral device coupled via a USB).

Moreover, the communication components 1540 may detect identifiers or include components operable to detect identifiers. For example, the communication components 1540 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1540, such as location via Internet Protocol (IP) geo-location, location via Wi-Fi® signal triangulation, location via detecting an NFC beacon signal that may indicate a particular location, and so forth.

In various example embodiments, one or more portions of the network 1532 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1532 or a portion of the network 1532 may include a wireless or cellular network and the coupling 1524 may be a Code Division Multiple Access (CDMA) connection, a Global System for Mobile communications (GSM) connection, or another type of cellular or wireless coupling. In this example, the coupling 1524 may implement any of a variety of types of data transfer technology, such as Single Carrier Radio Transmission Technology (IxRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1510 may be transmitted or received over the network 1532 using a transmission medium via a network interface device (e.g., a network interface component included in the communication components 1540) and utilizing any one of a number of well-known transfer protocols (e.g., hypertext transfer protocol (HTTP)). Similarly, the instructions 1510 may be transmitted or received using a transmission medium via the coupling 1522 (e.g., a peer-to-peer coupling) to the devices 1520. The term “transmission medium” shall be taken to include any intangible medium that is capable of storing, encoding, or carrying the instructions 1510 for execution by the machine 1500, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

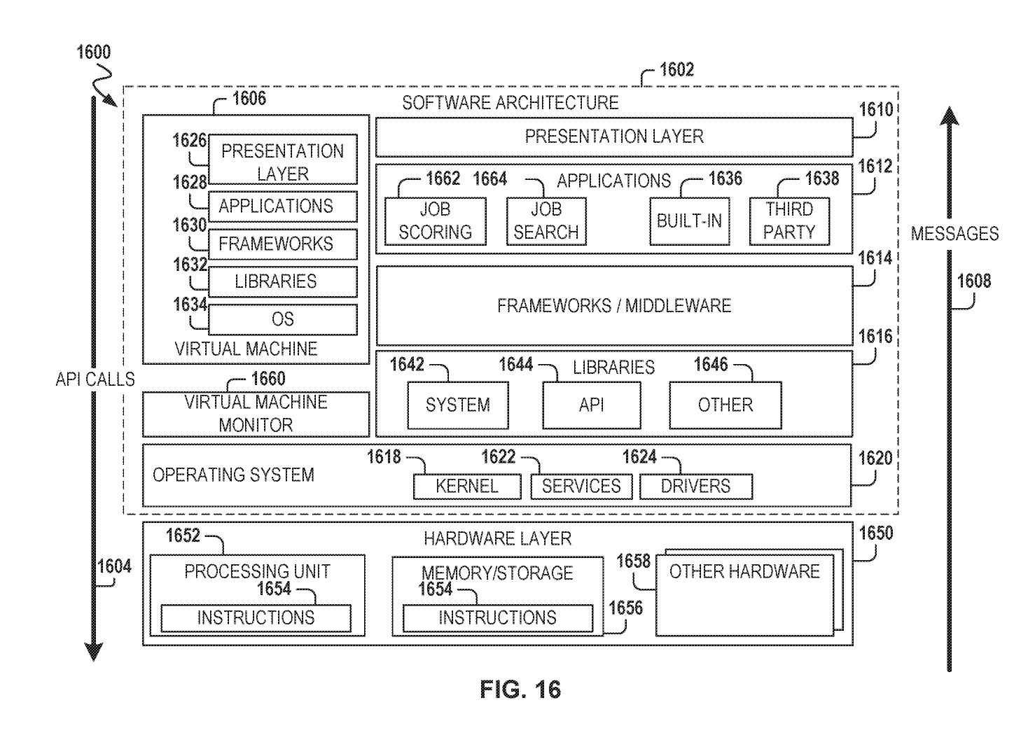

FIG. 16 is a block diagram 1600 illustrating a representative software architecture 1602, which may be used in conjunction with various hardware architectures herein described. FIG. 16 is merely a non-limiting example of a software architecture 1602, and it will be appreciated that many other architectures may be implemented to facilitate the functionality described herein. The software architecture 1602 may be executing on hardware such as a machine 1600 of FIG. 16 that includes, among other things, processors 1604, memory/storage 1606, and input/output (I/O) components 1618. A representative hardware layer 1650 is illustrated and can represent, for example, the machine 1600 of FIG. 16. The representative hardware layer 1650 comprises one or more processing units 1652 having associated executable instructions 1654. The executable instructions 1654 represent the executable instructions of the software architecture 1602, including implementation of the methods, modules, and so forth of the previous figures. The hardware layer 1650 also includes memory and/or storage modules 1656, which also have the executable instructions 1654. The hardware layer 1650 may also comprise other hardware 1658, which represents any other hardware of the hardware layer 1650, such as the other hardware illustrated as part of the machine 100.

In the example architecture of FIG. 16, the software architecture 1602 may be conceptualized as a stack of layers where each layer provides particular functionality. For example, the software architecture 1602 may include layers such as an operating system 1620, libraries 1616, frameworks/middleware 1614, applications 1612, and a presentation layer 1610. Operationally, the applications 1612 and/or other components within the layers may invoke application programming interface (API) calls 1604 through the software stack and receive a response, returned values, and so forth illustrated as messages 1608 in response to the API calls 1604. The layers illustrated are representative in nature, and not all software architectures have all layers. For example, some mobile or special-purpose operating systems may not provide a frameworks/middleware layer 1616, while others may provide such a layer. Other software architectures may include additional or different layers.

The operating system 1620 may manage hardware resources and provide common services. The operating system 1620 may include, for example, a kernel 1618, services 1622, and drivers 1624. The kernel 1618 may act as an abstraction layer between the hardware and the other software layers. For example, the kernel 1618 may be responsible for memory management, processor management (e.g., scheduling), component management, networking, security settings, and so on. The services 1622 may provide other common services for the other software layers. The drivers 1624 may be responsible for controlling or interfacing with the underlying hardware. For instance, the drivers 1624 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1616 may provide a common infrastructure that may be utilized by the applications 1612 and/or other components and/or layers. The libraries 1616 typically provide functionality that allows other software modules to perform tasks in an easier fashion than by interfacing directly with the underlying operating system 1620 functionality (e.g., kernel 1618, services 1622, and/or drivers 1624). The libraries 1616 may include system libraries 1642 (e.g., C standard library) that may provide functions such as memory allocation functions, string manipulation functions, mathematic functions, and the like. In addition, the libraries 1616 may include API libraries 1644 such as media libraries (e.g., libraries to support presentation and manipulation of various media formats such as MPEG4, H.264, MP3, AAC, AMR, JPG, PNG), graphics libraries (e.g., an OpenGL framework that may be used to render two-dimensional and three-dimensional graphic content on a display), database libraries (e.g., SQLite that may provide various relational database functions), web libraries (e.g., WebKit that may provide web browsing functionality), and the like. The libraries 1616 may also include a wide variety of other libraries 1646 to provide many other APIs to the applications 1612 and other software components/modules.

The frameworks 1616 (also sometimes referred to as middleware) may provide a higher-level common infrastructure that may be utilized by the applications 1612 and/or other software components/modules. For example, the frameworks 1616 may provide various graphic user interface (GUI) functions, high-level resource management, high-level location services, and so forth. The frameworks 1616 may provide a broad spectrum of other APIs that may be utilized by the applications 1612 and/or other software components/modules, some of which may be specific to a particular operating system or platform.

The applications 1612 include job-scoring applications 1662, job search/suggestions 1664, built-in applications 1636, and third-party applications 1638. The job-scoring applications 1662 comprise the job-scoring applications, as discussed above with reference to FIG. 11. Examples of representative built-in applications 1636 may include, but are not limited to, a contacts application, a browser application, a book reader application, a location application, a media application, a messaging application, and/or a game application. The third-party applications 1638 may include any of the built-in applications 1636 as well as a broad assortment of other applications. In a specific example, the third-party application 1638 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1638 may invoke the API calls 1604 provided by the mobile operating system such as the operating system 1620 to facilitate functionality described herein.

The applications 1612 may utilize built-in operating system functions (e.g., kernel 1618, services 1622, and/or drivers 1624), libraries (e.g., system libraries 1642, API libraries 1644, and other libraries 1646), or frameworks/middleware 1616 to create user interfaces to interact with users of the system. Alternatively, or additionally, in some systems, interactions with a user may occur through a presentation layer, such as the presentation layer 1610. In these systems, the application/module “logic” can be separated from the aspects of the application/module that interact with a user.

Some software architectures utilize virtual machines. In the example of FIG. 16, this is illustrated by a virtual machine 1606. A virtual machine creates a software environment where applications/modules can execute as if they were executing on a hardware machine (such as the machine 1600 of FIG. 16, for example). The virtual machine 1606 is hosted by a host operating system (e.g., operating system 1620 in FIG. 16) and typically, although not always, has a virtual machine monitor 1660, which manages the operation of the virtual machine 1606 as well as the interface with the host operating system (e.g., operating system 1620). A software architecture executes within the virtual machine 1606, such as an operating system 1634, libraries 1632, frameworks/middleware 1630, applications 1628, and/or a presentation layer 1626. These layers of software architecture executing within the virtual machine 1606 can be the same as corresponding layers previously described or may be different.

What is claimed is:

1. A method comprising:
identifying, by a server having at least one processor, a plurality of jobs presentable to a searching member in response to a search for jobs by the searching member, each job being offered by a respective company;
for each job, selecting former employees of the company offering the job;
determining a relation score for each employee of the company, the relation score being based on a similarity between the searching member and each employee;
calculating an employee fit score for the company based on historical interactions between the employees and the company;
calculating a cultural fit score for each job based on the relation scores and the employee fit score for the company offering the job;
ranking the plurality of jobs based on the cultural fit scores; and
causing a presentation of jobs from the plurality of jobs based on the ranking.

2. The method of claim 1, further comprising:
for each job, selecting, by the server, a plurality of current employees of the company offering the job;
determining a relation score for each current employee, the current relation score being based on a similarity between the searching member and each former employee, wherein the calculating of the cultural fit score for each job is based on the relation scores.

3. The method of claim 1, wherein the employee fit score is based on a loyalty value that is an average length of employment of the former employees with the company offering the job.

4. The method of claim 1, wherein the employee fit score is further based on a benefit value measuring a performance of the company in providing benefits to employees of the company.

5. The method of claim 1, wherein the similarity between the searching member and each employee is a value based on a comparison of a skill set of the searching member and a skill set of the employee.

6. The method of claim 5, wherein the value for the similarity is calculated by a machine-learning tool trained with member data, the machine-learning tool comparing data of the searching member with data of the former employee.

7. The method of claim 1, wherein selecting former employees of the company further includes:
selecting employees of the company that have similar skill sets to a skill set of the searching member.

8. The method of claim 7, further comprising determining a skill vectors based on a comparison of the skill set of the searching member and the skill sets of the employees and wherein the employees are selected based on the skill vectors surpassing a threshold value.

9. The method of claim 7, wherein the employees are selected based on the employees and the searching member having attained a common job title.

10. A system comprising
at least one processor of a machine; and
a memory storing instructions that, when executed by the at least one processor, cause the machine to perform operations comprising:
identifying, by a server having at least one processor, a plurality of jobs presentable to a searching member in response to a search for jobs by the searching member, each job being offered by a respective company;
for each job, selecting former employees of the company offering the job;
determining a relation score for each employee of the company, the relation score being based on a similarity between the searching member and each employee;
calculating an employee fit score for the company based on historical interactions between the employees and the company;
calculating a cultural fit score for each job based on the relation scores and the employee fit score for the company offering the job;
ranking the plurality of jobs based on the cultural fit scores; and
causing a presentation of jobs from the plurality of jobs based on the ranking.

11. The system of claim 10, wherein the operations further comprise:
for each job, selecting, by the server, a plurality of current employees of the company offering the job;
determining a relation score for each current employee, the current relation score being based on a similarity between the searching member and each former employee, wherein the calculating of the cultural fit score for each job is based on the relation scores.

12. The system of claim 11, wherein the employee fit score is based on a loyalty value that is based on an average length of employment of the former employees with the company offering the job.

13. The system of claim 10, wherein the employee fit score is further based on a benefit value measuring a performance of the company in providing benefits to employees of the company.

14. The system of claim 10, wherein the similarity between the searching member and each employee is a value based on a comparison of a skill set of the searching member and a skill set of the employee.

15. The system of claim 14, wherein the value for the similarity is calculated by a machine-learning tool trained with member data, the machine-learning tool comparing data of the searching member with data of the former employee.

16. The system of claim 10,
wherein selecting former employees of the company further includes:
selecting employees of the company that have similar skill sets to a skill set of the searching member.

17. The system of claim 16,
further comprising determining a skill vectors based on a comparison of the skill set of the searching member and the skill sets of the employees and wherein the employees are selected based on the skill vectors surpassing a threshold value.

18. The system of claim 16, wherein the employees are selected based on the employees and the searching member having attained a common job title.

19. A non-transitory machine-readable storage medium comprising instructions that, when executed by one or more processors of a machine, cause the machine to perform operations comprising:
identifying, by a server having at least one processor, a plurality of jobs presentable to a searching member in response to a search for jobs by the searching member, each job being offered by a respective company;
for each job, selecting former employees of the company offering the job;
determining a relation score for each employee of the company, the relation score being based on a similarity between the searching member and each employee;
calculating an employee fit score for the company based on historical interactions between the employees and the company;
calculating a cultural fit score for each job based on the relation scores and the employee fit score for the company offering the job;
ranking the plurality of jobs based on the cultural fit scores; and
causing a presentation of jobs from the plurality of jobs based on the ranking.

20. The non-transitory machine-readable storage medium of claim 19, further comprising:
for each job, selecting, by the server, a plurality of current employees of the company offering the job;
determining a relation score for each current employee, the current relation score being based on a similarity between the searching member and each former employee, wherein the calculating of the cultural fit score for each job is based on the relation scores.
